(19) United States
(12) Patent Application Publication
(10) Pub. No.: US 2024/0249300 A1
(43) Pub. Date: Jul. 25, 2024

(54) PROCESSING DEVICE, PROCESSING METHOD, AND PROCESSING PROGRAM

(71) Applicant: NTT QONOQ, INC., Tokyo (JP)

(72) Inventor: Toshimitsu NAKAMURA, Chiyoda-ku (JP)

(73) Assignee: NTT QONOQ, INC., Tokyo (JP)

(21) Appl. No.: 18/564,137

(22) PCT Filed: Jun. 3, 2022
(86) PCT No.: PCT/JP2022/022623

§ 371 Date: Nov. 27, 2023

(30) Foreign Application Priority Data
Jun. 8, 2021 (JP) 2021-096066

(51) Int. Cl. G06Q 30/0202; G06Q 30/0601

(52) U.S. Cl. CPC G06Q 30/0202; G06Q 30/0643

(57) ABSTRACT

A server device (10) includes: a construction unit (132) configured to construct a VR store from which a user is able to browse and purchase products in a virtual space and to provide the constructed virtual store to a user terminal used by the user; a clicking frequency counting unit (133) configured to count a browsing frequency of the products by the user and to record the browsing frequency in correlation with a viewpoint which is a browsing position; and a heat map preparing unit (134) configured to prepare a heat map image in which the browsing frequency is displayed on a map of the VR store in the form of a heat map.

### TECHNICAL FIELD

The present invention relates to a processing device, a processing method, and a processing program.

### BACKGROUND ART

In the related art, purchase of products using a website (an electronic commerce (EC) site) selling products over the Internet is generally used. Recently, techniques of providing the same extent of purchase experience as with purchase of products in actual stores to users by reproducing stores in a virtual space and cooperating with an EC site have been proposed.

### CITATION LIST

### Patent Literature

[Patent Literature 1] Japanese Unexamined Patent Publication No. 2004-220074

### SUMMARY OF INVENTION

### Technical Problem

By displaying a degree of congestion on a map in the form of a heat map, a degree of congestion in a store may be analyzed and a display of products therein may be changed. When a heat map indicating a degree of congestion is applied to a virtual space of a type in which a user moves between viewpoints which cannot be moved freely, there is a problem in that it is difficult to reflect a specific degree of congestion in a heat map by only counting the number of users visiting the viewpoints.

The present invention was made in consideration of the aforementioned circumstances and an objective thereof is to provide a processing device, a processing method, and a processing program that can prepare a detailed heat map indicating a degree of congestion in a purchase environment which is constructed in a virtual space.

### Solution to Problem

In order to solve the aforementioned problems and to achieve the objective, a processing device according to the present invention includes: a construction unit configured to construct a virtual store from which a user is able to browse and purchase products in a virtual space and to provide the constructed virtual store to a user terminal used by the user; a counting unit configured to count a browsing frequency of the products by the user and to record the browsing frequency in correlation with a viewpoint which is a browsing position; and a preparation unit configured to prepare a heat map image in which the browsing frequency is displayed on a map of the virtual store in the form of a heat map.

### Advantageous Effects of Invention

According to the present invention, it is possible to prepare a detailed heat map indicating a degree of congestion in a purchase environment which is constructed in a virtual space.

### BRIEF DESCRIPTION OF DRAWINGS

FIG. 1 is a block diagram illustrating an example of a configuration of a communication system according to an embodiment.

FIG. 2 is a plan view illustrating a part of a virtual reality (VR) shopping mall.

FIG. 3 is a diagram illustrating an example of the inside of a virtual store (VR store) which is displayed on a screen of a user terminal.

FIG. 4 is a block diagram illustrating an example of a configuration of a server device illustrated in FIG. 1.

FIG. 5 is a diagram illustrating an example of a heat map image which is prepared by a heat map preparing unit illustrated in FIG. 4.

FIG. 6 is a sequence diagram illustrating a processing sequence of a communication process which is performed by the communication system according to the embodiment.

FIG. 7 is a diagram illustrating a computer that executes a program.

### DESCRIPTION OF EMBODIMENTS

Hereinafter, a processing device, a processing method, and a processing program according to an embodiment of the present invention will be described in detail with reference to the accompanying drawings. The processing device, the processing method, and the processing program according to the present invention are not limited to the embodiment.

In the following embodiment, a routine of processes in a processing device, a processing method, and a processing program according to the embodiment will be sequentially described, and advantageous effects of the embodiment will be described thereafter.

### EMBODIMENT

The embodiment will be first described below. In this embodiment, a communication system for providing a shopping environment in a virtual space to a user will be described.

In a communication system according to the embodiment, a server device on a virtual reality (VR) shopping mall provider side that provides a shopping environment to a user constructs a virtual street in a virtual space and constructs a virtual shopping mall (a VR shopping mall) including a plurality of virtual stores (VR stores) in the street. In the embodiment, a browsing frequency of products corresponds to a degree of congestion, and a detailed heat map indicating a degree of congestion is prepared by preparing a heat map image in which a browsing frequency of products is displayed in the form of a heat map in correlation with a viewpoint which is a browsing position.

### [Configuration of Communication System]

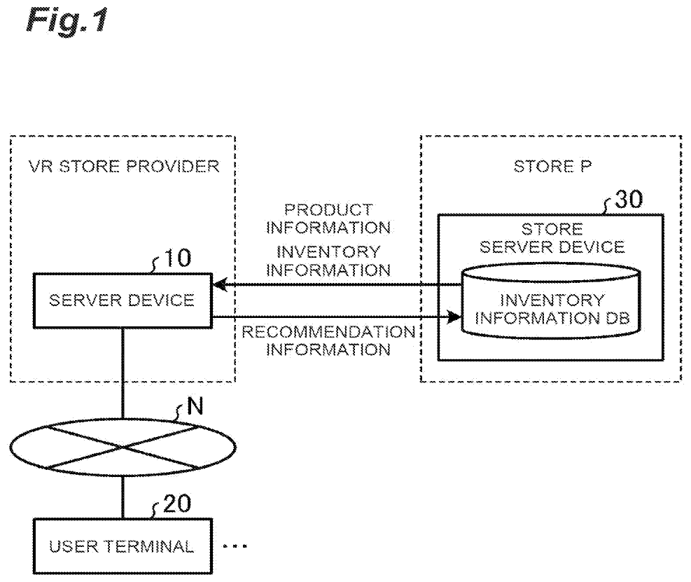

A configuration of the communication system according to the embodiment will be described below. FIG. 1 is a block diagram illustrating an example of the configuration of the communication system according to the embodiment.

As illustrated in FIG. 1, the communication system according to the embodiment includes a user terminal 20 which is used by each user and a server device 10 (a processing device) of a VR store provider. The server device 10 is connected to a store server device 30 of a store P selling products. The configuration illustrated in FIG. 1 is only an example and a specific configuration or the numbers of devices are not particularly limited.

The server device 10 of the VR store provider receives information on a VR store or products which can be displayed in an advertisement from the store server device 30 of the store P selling products and provides a VR store in which the products are displayed and a VR shopping mall including the VR store and street advertisements to a user.

The store server device 30 includes an inventory information DB of products stored therein. The store server device 30 transmits information on products which can be displayed in the VR store or the advertisements thereof out of products stored therein to the server device 10 via a network or the like. The store server device 30 transmits identification information, names, sizes, colors, prices, and inventory information of the products as product information. Actually, a plurality of stores and a plurality of store server devices 30 are provided.

The user terminal 20 is an information processing device such as a notebook personal computer (PC) or a desktop PC or a smart device such as a tablet or a smartphone. The user terminal 20 is connected to the server device 10 via a network N and is provided with a VR shopping mall. The user terminal 20 performs browsing of a store or an advertisement in a shopping mall, browsing of products and advertisements in a VR store, and purchase of a product in the provided VR shopping mall.

### [Browsing Example of Product]

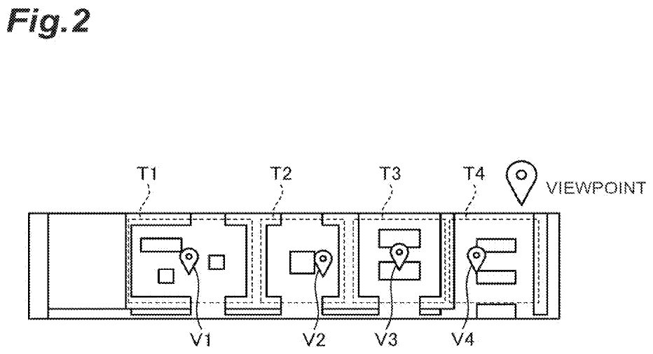

FIG. 2 is a plan view illustrating a part of a VR shopping mall. For example, as illustrated in FIG. 2, VR stores T1 to T4 are constructed in a line in a VR space in the VR shopping mall. In the VR stores T1 to T4, viewpoints V1 to V4 are set at predetermined positions in areas of the stores. A user can browse products in the VR stores T1 to T4 by operating the user terminal 20 and locating at the viewpoints V1 to V4.

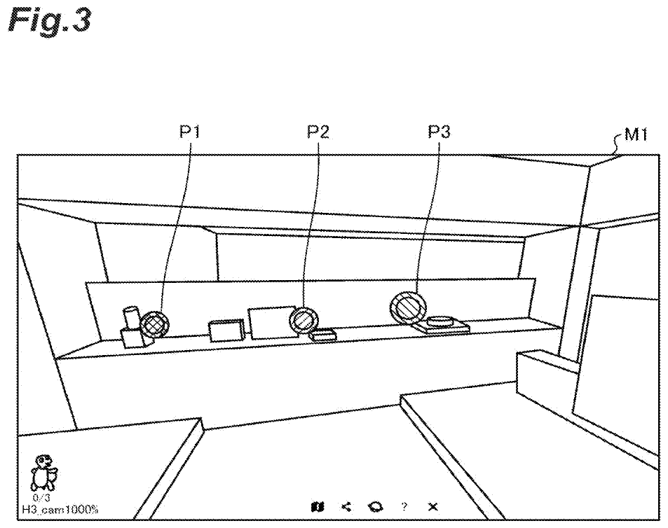

FIG. 3 is a diagram illustrating an example of the inside of a VR store displayed on a screen of the user terminal 20. In FIG. 3, the inside of the VR store T3 illustrated in FIG. 2 is illustrated. For example, it is assumed that the user is located at the viewpoint V3 of the VR store T3.

As illustrated in FIG. 3, click points P1 to P3 are displayed to correspond to products in the VR store T3. By clicking the click points P1 to P3, the user can browse products. The user can click the click points P1 to P3 of the products by locating at the viewpoint V3 of the VR store T3. Accordingly, the products of the VR store T3 can be browsed by the user by allowing the user located at the viewpoint V3 in the virtual space to click the click points P1 to P3. The user located at the viewpoint V3 can browse and refer to information such as type, color, size, price, and inventory information of each product by clicking the click points P1 to P3 and perform a process of purchasing products by performing a predetermined process.

Here, the server device 10 counts a clicking frequency in which users have clicked a click point as a browsing frequency of products and prepares a heat map image in which the browsing frequency is displayed in the form of a heat map to correspond to the positions of the viewpoints or the click points. In this way, in the embodiment, it is possible to prepare a detailed heat map indicating a degree of congestion even in a virtual space of a type in which a user moves between viewpoints which cannot be moved freely. The server device 10 illustrated in FIG. 1 will be described below.

### [Server Device]

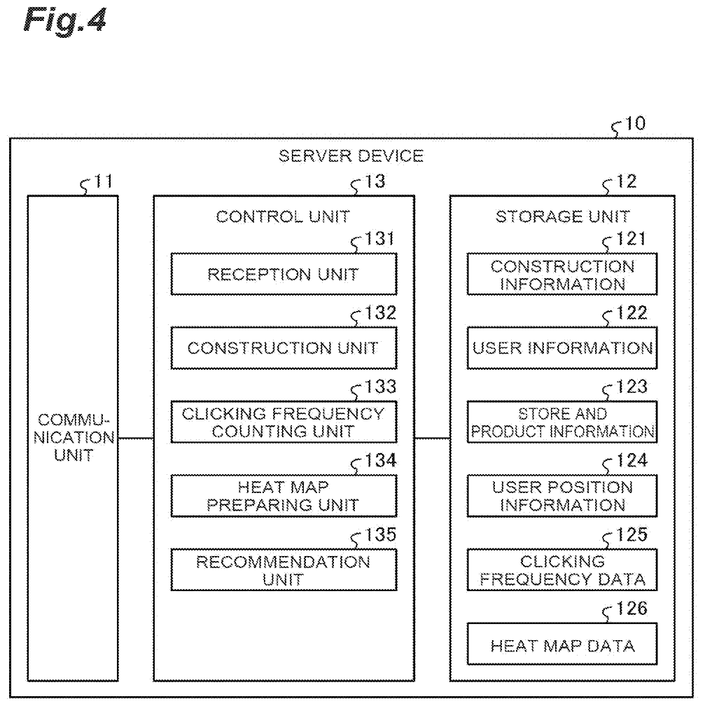

FIG. 4 is a block diagram illustrating an example of a configuration of the server device 10 illustrated in FIG. 1. As illustrated in FIG. 4, the server device 10 includes a communication unit 11 controlling communication of various types of information, a storage unit 12 storing data and programs required for various processes which are performed by a control unit 13, and the control unit 13 performing various processes. The processes of the constituent units of the server device 10 will be described below.

The communication unit 11 is a communication interface that transmits and receives various types of information to and from another device connected thereto via a network or the like. The communication unit 11 is realized by a network interface card (NIC) or the like and performs communication between another device and the control unit 13 (which will be described later) via an electrical communication line such as a local area network (LAN) or the Internet. For example, the communication unit 11 receives information of displayable products from the store server device 30 via the network. The communication unit 11 receives an entrance request for a VR shopping mall, an entrance request for a VR store, or a browse request or a purchase request for products from the user terminal 20 via the network N. The communication unit 11 transmits information on a product purchase procedure and inventory update after purchase of a product to the store server device 30.

The storage unit 12 is a storage device such as a hard disk drive (HDD) or a solid state drive (SSD). The storage unit 12 may be a data-rewritable semiconductor memory such as a random access memory (RAM), a flash memory, or a nonvolatile static random access memory (NVSRAM). The storage unit 12 stores an operating system (OS) or various programs which are executed by the server device 10. The storage unit 12 stores various types of information which are used to execute the programs. The storage unit 12 stores construction information 121, user information 122, store and product information 123, user position information 124, clicking frequency data 125, and heat map data 126.

The construction information 121 is information required to construct VR stores and a VR shopping mall in a virtual space. The construction information 121 includes image processing conditions or image processing programs for constructing VR stores and a VR shopping mall in a virtual space. The construction information 121 includes an image of VR stores and a VR shopping mall obtained by imaging the inside of each store, products, a streetscape, or outside views of stores, from a fixed point or by 360° or processing the images. For example, when VR stores and a VR shopping mall are constructed by computer graphics (CG), the construction information 121 is an image in which the inside of stores, products, a streetscape, and outside views of stores are reproduced. The construction information 121 includes image information or position information of the viewpoints or the click points.

The user information 122 is information on users who are registered as visitors of the VR stores and the VR shopping mall. The user information 122 includes, for example, IDs of users and purchase histories and browsing histories correlated with the user IDs. For example, a purchase history includes a purchase time, a name of a store in which a product has been purchased, a product ID, a product name, a product size, a product color, and a product number as items. For example, a browsing history includes a browsing time, a name of a store in which a product has been browsed, a product ID, a product name, a product size, a product color, and a product number as items.

The store and product information 123 is information on stores which are arranged in the VR shopping mall and products which are displayed in the VR stores. The store and product information 123 includes a store ID, a store type, and a product ID, a product name, a product size, a product color, and a product number of each product which can be displayed in each VR store or advertisement out of products stored in the store as items. For example, when a store P is a costume store, an image or a photograph of costumes or belongings which can be displayed in the VR store are stored in the store and product information 123 along with information on features such as sizes and colors and prices of products and the number of inventory products.

The user position information 124 is information in which position information of each user in the virtual space is correlated with time information and which is transmitted from the user terminal 20. The user position information 124 is, for example, periodically updated.

The clicking frequency data 125 stores the clicking frequencies of the viewpoints and the click points in correlation with positions of the viewpoints and the click points in the virtual space.

The heat map data 126 is a heat map image which is prepared by a heat map preparing unit 134 (which will be described later). The heat map data 126 is an image in which browsing frequencies of products are displayed in the form of a heat map on a map of each VR store.

The control unit 13 controls the server device 10 as a whole. The control unit 13 is, for example, an electronic circuit such as a central processing unit (CPU) or a micro processing unit (MPU) or an integrated circuit such as an application-specific integrated circuit (ASIC) or a field-programmable gate array (FPGA). The control unit 13 includes an internal memory storing programs or control data for defining various process routines and performs various processes using the internal memory. The control unit 13 serves as various processing units by causing various programs to operate. The control unit 13 includes a reception unit 131, a construction unit 132, a clicking frequency counting unit 133 (a counting unit), a heat map preparing unit 134 (a preparing unit), and a recommendation unit 135.

The reception unit 131 receives entrance into a VR shopping mall, entrance into a VR store in the VR shopping mall, browsing of products, and purchase of products from a user.

The construction unit 132 constructs a VR shopping mall and a VR store in a virtual space using an image or CG. When entrance of a user into the VR shopping mall is received, the construction unit 132 acquires the construction information 121 and constructs the VR shopping mall in the virtual space. Then, the construction unit 132 provides the VR shopping mall to the user terminal 20 used by the user. The construction unit 132 may change a landscape such as a streetscape of the VR shopping mall or products displayed in the VR store for each season.

In the VR shopping mall, arrangement of stores, appearances of stores, roads, and corresponding advertisements are constructed based on an actual streetscape. In the VR shopping, a user can move the user's avatar to walk on an actual streetscape. In the VR shopping mall, a user can enter a selected VR store, for example, by clicking or tapping a store name displayed on the outside view of the store or an entrance of the store.

When entrance of the user into the VR store is received, the construction unit 132 constructs the VR store in the virtual space. Then, the construction unit 132 provides the constructed VR store to the user terminal 20 used by the user.

In the VR store, an inner appearance is constructed based on an actual store, and displayable products out of products stored in the actual store are displayed in a display manner in the actual store (products are arranged in a line in a showcase or the like). In the displayed products, product information (such as type, color, shape, size, price, and inventory) is provided to be browsed by allowing a user located at the viewpoint of the store to click a click point. The displayed products can also be purchased. In the VR store, an advertisement of products displayed in the store can also be displayed in an arbitrary area in the store.

When entrance of the user into the VR shopping mall is received, the construction unit 132 may construct VR stores arranged in the VR shopping mall along with the VR shopping mall.

The clicking frequency counting unit 133 counts browsing frequencies of products by a user and records the counted data in correlation with the viewpoint. The clicking frequency counting unit 133 counts a clicking frequency of a click point by a user as the browsing frequency of a product and records the counted browsing frequency in correlation with the viewpoint and the click point of the product. The clicking frequency counting unit 133 stores the counted browsing frequency in the clicking frequency data 125 in correlation with the viewpoint and the click point of the product.

The heat map preparing unit 134 prepares a heat map image in which the browsing frequencies of products are displayed in the form of a heat map on a map of the VR store. The heat map preparing unit 134 prepares a heat map image in which browsing frequencies of a product corresponding to viewpoints and click points are displayed in the form of a heat map on a map of the VR store in correlation with the positions of the viewpoints or the click points.

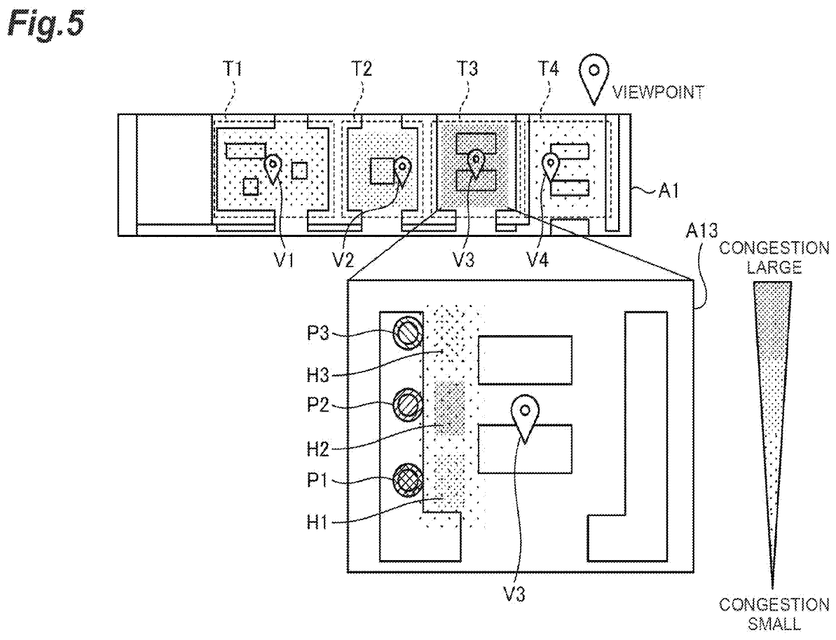

FIG. 5 is a diagram illustrating an example of a heat map image which is prepared by the heat map preparing unit 134 illustrated in FIG. 4. A heat map image A1 illustrated in an upper part of FIG. 5 is a heat map image of each store of the VR stores T1 to T4 illustrated in FIG. 2, and a heat map image A13 illustrated in a lower part of FIG. 5 is a heat map image of the VR store T3.

As illustrated in the heat map image A1, the heat map preparing unit 134 considers the browsing frequencies of products to correspond to a degree of congestion and displays the browsing frequencies of products in the form of a heat map in correlation with viewpoints V1 to V4 of the VR stores T1 to T4. It is possible to easily recognize a degree of congestion of each of the VR stores T1 to T4 using the heat map image A1.

As illustrated in heat maps H1 to H3 of the heat map image A13, the heat map preparing unit 134 displays the browsing frequencies of products in the form of a heat map in correlation with click points P1 to P3 of the VR store T3. It is possible to easily recognize detailed degrees of congestion of products in the VR store T3 using the heat map image A13 in which what product is more browsed is visibly displayed.

The recommendation unit 135 recommends, for example, recommendation information indicating a display example of products in a VR store or a display example of products in an actual store to a store opening party of the VR store based on the heat map image. The recommendation unit 135 transmits recommendation information indicating a display example of products in a VR store or a display example of products in an actual store to the store server device 30 of the store P. The recommendation unit 135 may recommend information to both the actual store and the VR store using the heat map image of the VR store. The recommendation unit 135 recommends products and arrangement of the products. The recommendation unit 135 may recommend one of products and arrangement of the products or recommend both the products and the arrangement of the products.

Specifically, since the degree of congestion of the click point P2 is the largest as illustrated in the heat map image A13, the recommendation unit 135 transmits a display example of products in which the degree of congestion in the VR store is distributed by arranging products corresponding to the click point P2 at another position to the store server device 30. The recommendation unit 135 transmits a display example of a VR store in which products to be sold to customers are arranged at the position corresponding to the click point P2 because the degree of congestion of the click point P2 is the largest to the store server device 30.

The recommendation unit 135 determines that a product corresponding to the click point P2 is more often browsed because the degree of congestion of the click point P2 is the largest and transmits a display example in which the product corresponding to the click point P2 is arranged in a shelf easily seen by customers in an actual store to the store server device 30. For example, the recommendation unit 135 transmits a display example in which one or both of a product recommended by the recommendation unit 135 and a product selected on the actual store side are arranged at the position corresponding to the click point P2 in the actual store to the store server device 30 because the degree of congestion of the click point P2 is the largest.

The recommendation unit 135 may recommend information indicating a product of which the browsing frequency is greater than a predetermined number out of products in the VR store to a user based on the heat map image. The recommendation unit 135 transmits recommendation information indicating a product of which the browsing frequency is greater than a predetermined number out of the products in the VR store to the user terminal 20.

Specifically, the recommendation unit 135 determines that a product corresponding to the click point P2 is most often browsed because the degree of congestion of the click point P2 is the largest as illustrated in the heat map image A13 and transmits recommendation information in which the product corresponding to the click point P2 is selected as a recommended product to the user terminal 20. The recommendation unit 135 determines that the VR store T3 is most often visited by users because the degree of congestion of the VR store T3 is the largest as illustrated in the heat map image A1 and transmits recommendation information in which the VR store T3 is selected as a recommended store to the user terminal 20.

### [Routine of Communication Process]

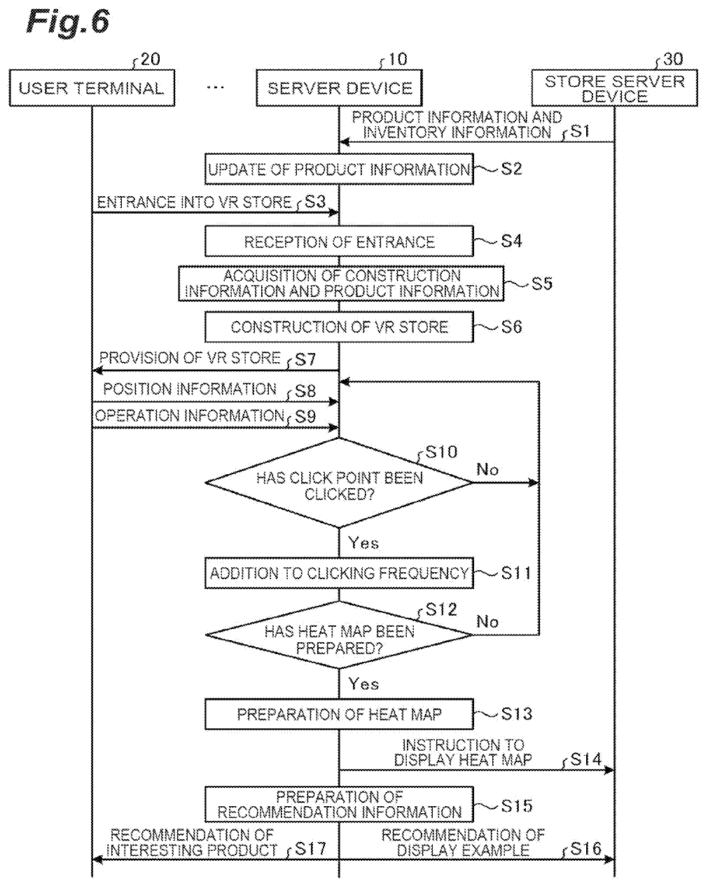

FIG. 6 is a sequence diagram illustrating a routine of a communication process which is performed by the communication system according to the embodiment.

As illustrated in FIG. 6, when product information and inventory information are received from the store server device 30 (Step S1), the server device 10 updates the store and product information 123 (Step S2).

In the server device 10, when the reception unit 131 receives a request for entrance into a VR store from the user terminal 20 (Steps S3 and S4), the construction unit 132 acquires the construction information 121 and the store and product information 123 (Step S5) and constructs a VR store in a virtual space (Step S6). Then, the construction unit 132 provides a VR shopping mall to the user terminal 20 (Step S7).

The server device 10 acquires position information of a user in the VR store and operation information of the user from the user terminal 20 (Steps S8 and S9) and determines whether a click point has been clicked by the user based on the position information and the operation information of the user (Step S10).

When a click point has been clicked (Step S10: YES), the server device 10 counts a clicking frequency of the click point and adds the counted frequency to the clicking frequency stored in correlation with the position of the click point (Step S11).

The server device 10 determines whether a heat map is to be prepared (Step S12). A heat map may be prepared every predetermined time or when a store side or a user side requests recommendation information to be transmitted.

When a click point has not been clicked (Step S10: NO) or a heat map is not to be prepared (Step S12: NO), the server device 10 acquires position information of the user in the VR store and the operation information of the user (Steps S8 and S9) and performs the determination process of Step S10.

When a heat map is to be pared (Step S12: YES), the server device 10 prepares a heat map image in which a browsing frequency of a product corresponding to the viewpoint and the click point is displayed on a map of the VR store in the form of a heat map in correlation with the positions of the viewpoint or the click points (Step S13).

Then, for example, the server device 10 transmits the prepared heat map and an instruction to display the heat map to the store server device 30 such that an operator of the store server device 30 views the heat map (Step S14).

The server device 10 prepares recommendation information indicating a display example of products in the VR store or a display example of products in an actual store based on the prepared heat map image and transmits the recommendation information to the store server device 30 (Steps S15 and S16). The server device 10 may prepare recommendation information in which a product of which the browsing frequency is greater than a predetermined number out of the products in the VR store is recommended as an interesting product based on the heat map image and transmit the recommendation information to the user terminal 20 (Steps S15 and S17).

### [Advantageous Effects of Embodiment]

As described above, the server device 10 according to the embodiment can prepare a detailed heat map indicating a degree of congestion by considering a browsing frequency of a product to be a degree of congestion and preparing a heat map image in which the browsing frequency of the product is displayed in the form of a heat map in correlation with a viewpoint.

The server device 10 counts a clicking frequency of a click point by a user as a browsing frequency of a product and prepares a heat map image in which the clicking frequency is displayed in the form of a heat map in correlation with a position of a viewpoint or the click point. Accordingly, according to the embodiment, it is possible to prepare a detailed heat map indicating a degree of congestion even in a virtual space of a type in which a user moves between viewpoints which cannot move freely.

The server device 10 recommends recommendation information indicating a display example of products in a VR store or a display example of products in an actual store to a store opening party of the VR store based on the heat map image indicating a degree of congestion. By changing a display of products in the VR store or a display of products in the actual store according to this recommendation, it is possible to prompt a user or a customer of the store to purchase products.

The server device 10 recommends information indicating a product of which the browsing frequency is greater than a predetermined number out of products in the VR store to a user based on the heat map image indicating a degree of congestion. The user can easily recognize a product which is browsed by more users with reference to the recommendation and perform smooth purchase.

The server device 10 may prepare a heat map of the whole VR shopping mall in addition to heat maps of the inside of a VR store or a plurality of VR stores such that users can recognize a degree of congestion of the VR shopping mall. At that time, the server device 10 may recommend an arrangement position example of VR stores in the VR shopping mall such that congestion disperses based on the heat map.

[System configuration and the like] Each constituent element of each device that has been illustrated is functional and conceptual and does not need to be necessarily physically configured as illustrated in the drawings. In other words, a specific form of distribution/integration of each device is not limited to that illustrated in the drawing, and all or some thereof can be configured with being functionally or physically distributed/integrated in an arbitrary unit in accordance with various loads, a use status, and the like. In addition, the whole or an arbitrary part of each processing function performed in each device may be realized by a CPU and a GPU (Graphics Processing Unit) and programs that are interpreted and executed by the CPU or the GPU or may be realized by hardware according to wired logics.

Furthermore, among processes described in this embodiment, all or some of the processes described to be automatically performed may be manually performed, or all or some of the processes described to be manually performed may be automatically performed using a known method. Other than that, a processing sequence, a control sequence, a specific name, and information including various kinds of data and parameters illustrated in the specification or the drawings described above may be arbitrarily changed unless otherwise mentioned.

[Program] In addition, a program in which the process performed by the server apparatus 10 described in the embodiment described above is described using a computer-executable language may be generated. For example, a program in which the process performed by the server apparatus 10 according to the embodiment is described using a computer-executable language may be generated as well. In such a case, by a computer executing the program, effects similar to those of the embodiment described above can be acquired. In addition, by recording such a program on a computer-readable recording medium and causing a computer to read and execute the program recorded on this recording medium, the process similar to that according to the embodiment described above may be realized.

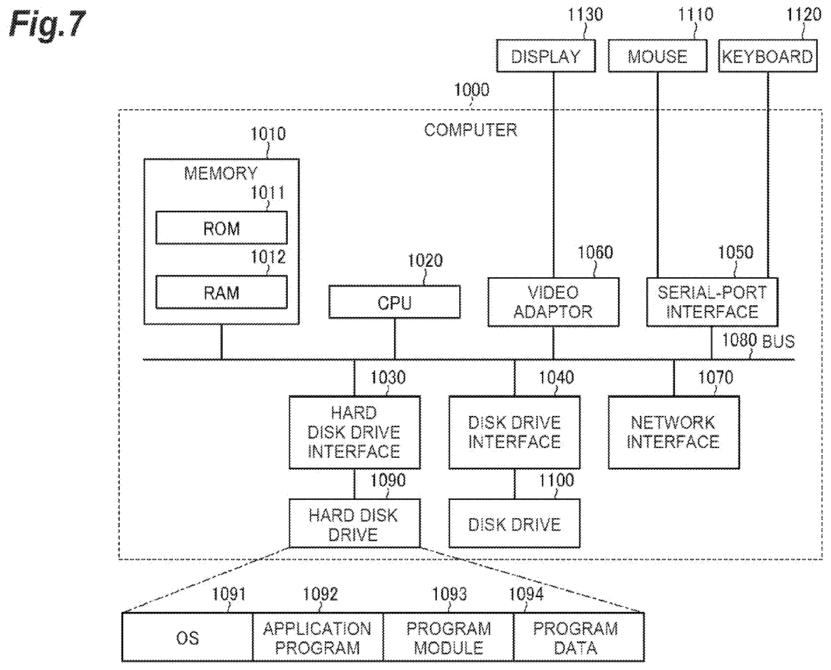

FIG. 7 is a diagram illustrating a computer executing a program. As illustrated in FIG. 7, the computer 1000, for example, includes a memory 1010, a CPU 1020, a hard disk drive interface 1030, a disk drive interface 1040, a serial port interface 1050, a video adaptor 1060, and a network interface 1070, and such units are connected through a bus 1080.

As illustrated in FIG. 7, the memory 1010 includes a read only memory (ROM) 1011 and a RAM 1012. For example, the ROM 1011 stores boot programs such as a Basic Input Output System (BIOS) and the like. As illustrated in FIG. 7, the hard disk drive interface 1030 is connected to a hard disk drive 1090. The disk drive interface 1040 is connected to a disk drive 1100. For example, a loadable/unloadable storage medium such as a magnetic disk, an optical disc, or the like is inserted into the disk drive 1100. For example, the serial port interface 1050 is connected to a mouse 1110 and a keyboard 1120. For example, the video adaptor 1060 is connected to a display 1130.

Here, as illustrated in FIG. 7, the hard disk drive 1090, for example, stores an OS 1091, an application program 1092, a program module 1093, and program data 1094. In other words, the program described above, for example, is stored in the hard disk drive 1090 as a program module in which instructions executed by the computer 1000 are described.

In addition, various kinds of data described in the embodiment described above, for example, is stored in the memory 1010 or the hard disk drive 1090 as program data. Then, the CPU 1020 reads the program module 1093 and the program data 1094 stored in the memory 1010 and the hard disk drive 1090 into the RAM 1012 as necessary and performs various processing sequences.

In addition, the program module 1093 and the program data 1094 relating to the program are not limited to being stored in the hard disk drive 1090 and, for example, may be stored in a loadable/unloadable storage medium and read by the CPU 1020 through a disk drive or the like. Alternatively, the program module 1093 and the program data 1094 relating to the program may be stored in another computer connected through a network (a local area network (LAN), a wide area network (WAN), or the like) and read by the CPU 1020 through the network interface 1070.

Like the embodiment described above and modifications thereof belong to the technology disclosed in the present application, they belong to the scope of inventions described in the claims and equivalency thereof.

### REFERENCE SIGNS LIST

10 Server device
11 Communication unit
12 Storage unit
13 Control unit
20 User terminal
30 Store server device 008
121 Construction information
122 User information

1. A processing device comprising:
a construction unit configured to construct a virtual store from which a user is able to browse and purchase products in a virtual space and to provide the constructed virtual store to a user terminal used by the user;
a counting unit configured to count a browsing frequency of the products by the user and to record the browsing frequency in correlation with a viewpoint which is a browsing position; and
a preparation unit configured to prepare a heat map image in which the browsing frequency is displayed on a map of the virtual store in the form of a heat map.

2. The processing device according to claim 1, wherein the products are able to be browsed by the user by allowing the user located at the viewpoint in the virtual space to click a click point displayed in correlation with each product, and
wherein the counting unit counts a clicking frequency in which each click point is clicked by the user as the browsing frequency of the corresponding product and records the counted browsing frequency in correlation with the viewpoint and the click point of the corresponding product.

3. The processing device according to claim 2, wherein the preparation unit prepares a heat map image in which the browsing frequency corresponding to the viewpoint and the click point is displayed on a map of the virtual store in the form of a heat map to correspond to a position of the corresponding viewpoint or click point.

4. The processing device according to claim 1, further comprising a recommendation unit configured to recommend recommendation information indicating a display example of products in the virtual store or a display example of products in an actual store to a store opening side of the virtual store based on the heat map image.

5. The processing device according to claim 1, further comprising a recommendation unit configured to recommend information indicating a product of which the browsing frequency is greater than a predetermined number out of the products in the virtual store to the user based on the heat map image.

6. A processing method that is performed by a processing device, the processing method comprising:
a step of constructing a virtual store from which a user is able to browse and purchase products in a virtual space and providing the constructed virtual store to a user terminal used by the user;
a step of counting a browsing frequency of the products by the user and recording the browsing frequency in correlation with a viewpoint which is a browsing position; and
a step of preparing a heat map image in which the browsing frequency is displayed on a map of the virtual store in the form of a heat map.

7. A processing program causing a computer to perform:
a step of constructing a virtual store from which a user is able to browse and purchase products in a virtual space and providing the constructed virtual store to a user terminal used by the user;
a step of counting a browsing frequency of the products by the user and recording the browsing frequency in correlation with a viewpoint which is a browsing position; and
a step of preparing a heat map image in which the browsing frequency is displayed on a map of the virtual store in the form of a heat map.

8. The processing device according to claim 2, further comprising a recommendation unit configured to recommend recommendation information indicating a display example of products in the virtual store or a display example of products in an actual store to a store opening side of the virtual store based on the heat map image.

9. The processing device according to claim 3, further comprising a recommendation unit configured to recommend recommendation information indicating a display example of products in the virtual store or a display example of products in an actual store to a store opening side of the virtual store based on the heat map image.

10. The processing device according to claim 2, further comprising a recommendation unit configured to recommend information indicating a product of which the browsing frequency is greater than a predetermined number out of the products in the virtual store to the user based on the heat map image.

11. The processing device according to claim 3, further comprising a recommendation unit configured to recommend information indicating a product of which the browsing frequency is greater than a predetermined number out of the products in the virtual store to the user based on the heat map image.
